(19) United States
(12) Patent Application Publication
(10) Pub. No.: US 2024/0312741 A1
(43) Pub. Date: Sep. 19, 2024

(54) High-flow current capacity contact and vacuum interrupter applied therefor

(71) Applicant: XI'AN JIAOTONG UNIVERSITY, Xi'an (CN)

(72) Inventors: Hui Ma, Xi'an (CN); Peicheng Huang, Xi'an (CN); Hao Cheng, Xi'an (CN); Yirui Zhang, Xi'an (CN); Zhiyuan Liu, Xi'an (CN); Yingsan Geng, Xi'an (CN); Jianhua Wang, Xi'an (CN)

(21) Appl. No.: 18/675,136

(22) Filed: May 27, 2024

(30) Foreign Application Priority Data
Jun. 14, 2023 (CN) 202310704969.6

(51) Int. Cl. H01H 33/664; H01H 33/66

(52) U.S. Cl. CPC H01H 33/664; H01H 33/6606

(57) ABSTRACT

A high-flow current capacity contact and a vacuum interrupter applied therefor are provided, wherein the high-flow current capacity contact includes: a static contact combination and a dynamic contact combination. The static contact combination includes a static conducting rod, a static excitation contact base welded on an end of the static conducting rod, a static stainless-steel supporter and a static contact blade with grooves opened. The dynamic contact combination includes: a dynamic conducting rod, a dynamic excitation contact base welded on an end of the dynamic conducting rod, a dynamic stainless-steel supporter and a dynamic contact blade. The static excitation contact base matches with the static stainless-steel supporter. Grooves opening direction of the static contact blade with the grooves and the dynamic contact blade with the grooves are matched, and the grooves opening direction thereof are aligned.

### CROSS REFERENCE OF RELATED APPLICATION

The present application claims priority under 35U.S.C. 119(a-d) to CN CN202310704969.6, filed Jun. 14, 2023.

### BACKGROUND OF THE PRESENT INVENTION

### Field of Invention

The present invention relates to the technical field of is a large-current vacuum breaker, and more particularly to a high-flow current capacity contact and a vacuum interrupter applied therefor.

### Description of Related Arts

With the development of power systems, the application of vacuum circuit breakers and related vacuum switch technical equipment in the entire power system also develop rapidly. Vacuum interrupter gradually develops from the initial plate structure into various magnetic field control contact structures, which mainly includes the transverse magnetic field contact structure and the axial magnetic field contact structure, wherein the axial magnetic field technology forms a magnetic field with an arc current in parallel through the contact structure, making the vacuum arc distribution more uniform, reducing the agglomeration of the vacuum arc, reducing the ablation of the arc on the surface of the contact, and improving the switching ability of the switch.

However, there is a contradiction between the improvement of the rated short-circuit current level of the vacuum interrupter and the improvement of the rated current level, that is, as the vacuum interrupter develops towards a high voltage and large capacity, the high-opening ability inevitably introduces a large vacuum arc control magnetic field, such as a stronger axial magnetic field, which exacerbates the complexity of the contact structure and the circuit resistance of the conductive circuit. Therefore, temperature overheating of the vacuum interrupter utilizing the axial magnetic contact at the rated current level severely restricts the increasing level of the breaking current of the rated short circuit thereof.

Unlike the SF₆ interrupter products, the main contact of the vacuum switch performs heat dissipation mainly relying on thermal conductivity in the vacuum environment. When the rated current of the interrupter is high, the temperature rising problem is even more prominent. When the temperature rising of the interrupter is too high, in addition to the mechanical strength of the conductive material is affected, the surface of the conductor is prone to oxidation to generate oxides, which increases the contacting resistance of the conductive body. Meanwhile, excessive temperature rising also increases the dielectric loss of the insulation parts and accelerates the aging of the insulation parts.

### SUMMARY OF THE PRESENT INVENTION

In order to solve the problems existed above the conventional arts, an object of the present invention is to provide a high-flow current capacity contact and a vacuum interrupter applied therefor, so as to improve rating through-flow and reduce through-flow loss under the premise of not losing the excitation intensity.

Accordingly, in order to achieve the above objects, the present invention adopts technical solutions as follows.

A high-flow current capacity contact, comprises: a static contact combination and a dynamic contact combination, wherein:
the static contact comprises a static excitation contact base, wherein a center on a first plane of the static excitation contact base is coaxially connected with a static conducting rod, and an end of a circular column on a second plane of the static excitation contact base is coaxially connected with a static contact blade;
a plurality of static terminal extending through-flow structures extending towards a center of the static excitation contact base are uniformly provided on the circular column of the static excitation contact base in integrity; an ending plane of the plurality of static terminal extending through-flow structures protrudes a circular end plane of the static excitation contact base, end portions of the plurality of the static terminal extending through-flow structures are fixedly connected with the static contact blade; a static stainless-steel supporter is coaxially provided in the circular column of the static excitation contact base, a plurality of static grooves 401 are uniformly opened on the static stainless-steel supporter, positions and sizes of the static grooves enable the static terminal extending through-flow structures to be putted in, but sizes of the static grooves are greater than sizes of the static terminal extending through-flow structures, in such a manner that the static terminal extending through-flow structures are not in contact with the static stainless-steel supporter to form a through-flow gap; the static stainless-steel supporter is not fixedly connected with the static contact blade;
the dynamic contact combination comprises a dynamic excitation contact base, wherein a center on a first plane of the dynamic excitation contact base is coaxially connected with a dynamic conducting rod, and an end of a circular column on a second plane of the dynamic excitation contact base is coaxially connected with a dynamic contact blade;
a plurality of dynamic terminal extending through-flow structures extending towards a center of the dynamic excitation contact base are uniformly provided on the circular column of the dynamic excitation contact base in integrity; an ending plane of the plurality of dynamic terminal extending through-flow structures protrudes a circular end plane of the dynamic excitation contact base, end portions of the plurality of the dynamic terminal extending through-flow structures are fixedly connected with the dynamic contact blade; a dynamic stainless-steel supporter is coaxially provided in the circular column of the dynamic excitation contact base, a plurality of dynamic grooves are uniformly opened on the dynamic stainless-steel supporter, positions and sizes of the dynamic grooves enable the dynamic terminal extending through-flow structures to be putted in, but sizes of the dynamic grooves are greater than sizes of the dynamic terminal extending through-flow structures, in such a manner that the dynamic terminal extending through-flow structures are not in contact with the static stainless-steel supporter to form a through-flow gap; the dynamic stainless-steel supporter is not fixedly connected with the dynamic contact blade; and
the static contact blade are in opposite position with the dynamic contact blade, and grooves opening positions of the static contact blade correspond to grooves opening positions of the dynamic contact blade; the grooves opening positions of the static contact blade are aligned with an protruding position edge of the static terminal extending through-flow structures on the static excitation contact base; and the grooves opening positions of the dynamic contact blade are aligned with an protruding position edge of the dynamic terminal extending through-flow structures on the dynamic excitation contact base.

Preferably, the static excitation contact base and the dynamic excitation contact base are a coil-type excitation contact base or a cup-shaped grooves excitation contact base.

Preferably, an amount of the static terminal extending through-flow structures on the circular column of the static excitation contact base is equal to or less than an amount of the static grooves; an extending distance L of the static terminal extending through-flow structures towards the center of the static excitation contact base is less than 80% of a radius of the static excitation contact base; and a thickness D of the static terminal extending through-flow structures 301 is less than 80% of a thickness of the static excitation contact base; and
an amount of the dynamic terminal extending through-flow structures on the circular column of the dynamic excitation contact base is equal to or less than an amount of the dynamic grooves; an extending distance L of the dynamic terminal extending through-flow structures towards the center of the dynamic excitation contact base is less than 80% of a radius of the dynamic excitation contact base; and a thickness D of the dynamic terminal extending through-flow structures is less than 80% of a thickness of the dynamic excitation contact base.

Preferably, a groove-opening amount of the static contact blade 104 is equal to or greater than an amount of the static terminal extending through-flow structures 301; and a groove-opening amount of the dynamic contact blade is equal to or greater than an amount of the dynamic terminal extending through-flow structures.

A vacuum interrupter, comprises: the high-flow current capacity contact; a vacuum interrupter static cover plate welded on the static conducting rod; a static insulation shell connected with the vacuum interrupter static cover plate; a dynamic insulation shell connected with the static insulation shell; a vacuum interrupter dynamic cover plate welded on the dynamic conducting rod and provided on a low portion of the vacuum interrupter; and a static terminal shielding, a central shielding and a dynamic terminal shielding which are distributed inside the vacuum interrupter from top to bottom.

Compared with the conventional arts, the present invention has beneficial effects as follows.
(1) The overall contact structure is simple. Only the flow-through structure of the static and dynamic excitation contact bases are extended along the center direction thereof, and thus increasing a contacting area on the connecting position between the static and dynamic contact blades and the static and dynamic excitation contact bases, increasing the cross-sectional area of the current, and reducing the current density of the connection. When the contact is closed, the vortex loss generated by the conducting the current while flowing through the contacting area on the center of the static and dynamic contact combination.
(2) Static and dynamic stainless-steel supporters have circle symmetrical groove structures, so as to match the extending through-flow structures of the static and dynamic excitation contact base, to ensure the groove-shaped structure and the extending through-flow structure are matched both in position and in size without contacting each other, and meanwhile supporting the dynamic and static contact blades.
(3) Static end and dynamic excitation contact base can be a cup-shaped groove contact structure or coil-type excitation contact structure, and the extending through-flow has generality in utilization, so as to achieve improving rating through-flow and reducing through-flow loss under the premise of not losing the excitation intensity.

### BRIEF DESCRIPTION OF THE DRAWINGS

FIG. 1 is a schematic diagram of a high-flow current capacity contact according to a preferred embodiment of the present invention.

FIG. 2 (a) is a top view of a static excitation contact base according to the preferred embodiment of the present invention.

FIG. 2 (b) is a top view of a dynamic excitation contact base according to the preferred embodiment of the present invention.

FIG. 2 (c) is a side view of the static excitation contact base according to the preferred embodiment of the present invention.

FIG. 2 (d) is a side view of the dynamic excitation contact base according to the preferred embodiment of the present invention.

FIG. 3 (a) is a top view of the static stainless-steel supporter according to the preferred embodiment of the present invention.

FIG. 3 (b) is a top view of the dynamic stainless-steel supporter structure according to the preferred embodiment of the dynamic end of the present invention.

FIG. 3 (c) is a side view of the static stainless-steel supporter according to the preferred embodiment of the present invention.

FIG. 3 (d) is a side view of the dynamic stainless-steel supporter according to the preferred embodiment of the dynamic end of the present invention.

FIG. 4 is a schematic matching diagram of the static excitation contact base and the static stainless-steel supporter according to the preferred embodiment of the present invention.

FIG. 5 is a schematic matching diagram of the excitation contact base and its corresponding contact blade with a slot according to the preferred embodiment of the present invention.

FIG. 6 is a top view of the excitation contact base while being embodied as an excitation contact with a cup-shaped groove according to the preferred embodiment of the present invention.

FIG. 7 is a side view of the excitation contact base while being embodied as the excitation contact with the cup-shaped groove according to the preferred embodiment of the present invention.

FIG. 8 is an axial sectional view of the high-flow current capacity contact according to the preferred embodiment of the present invention.

FIG. 9 is a plane schematic diagram of a vacuum interrupter for applying the high-flow current capacity contact according to the preferred embodiment of the present invention.

### DETAILED DESCRIPTION OF THE PREFERRED EMBODIMENT

The following combined with the attached drawings and specific embodiments, describes the present invention further in detail.

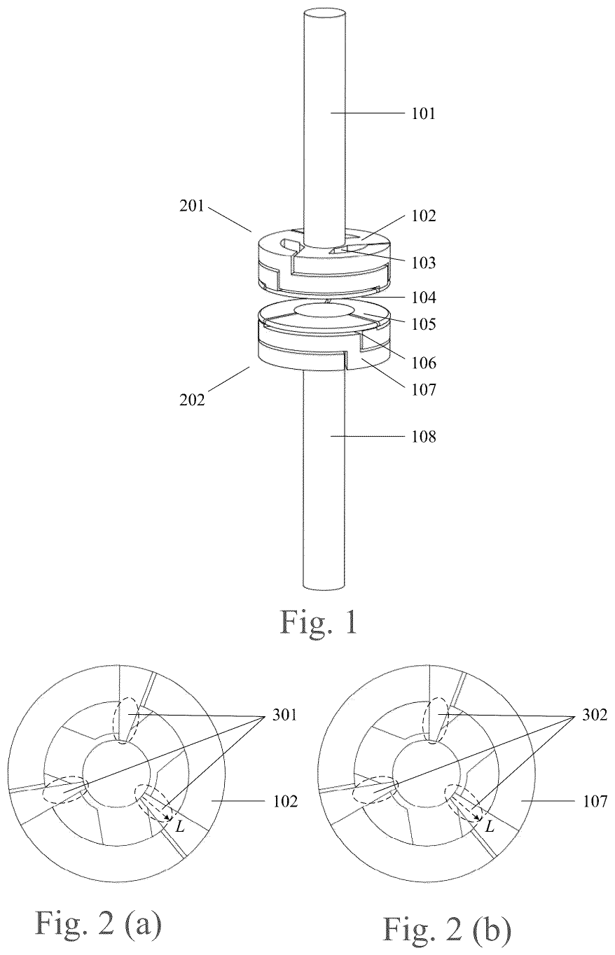

As shown in FIG. 1 and FIG. 8, the present invention provides a high-flow current capacity contact comprises two parts: a static contact combination 201 and a dynamic contact combination 202.

The static contact 201 comprises: a static conducting rod 101, a static excitation contact base 102, a static stainless-steel supporter 103 and a static contact blade 104 with grooves opened. A center on a first plane of the static excitation contact base 102 is coaxially welded with a static conducting rod 101, and an end of a circular column on a second plane of the static excitation contact base 102 is coaxially welded with a static contact blade 104. A static stainless-steel supporter 103 is coaxially provided in the circular column of the static excitation contact base 102. The dynamic contact combination 202 comprises: a dynamic conducting rod 108, a dynamic excitation contact base 107, a dynamic stainless-steel supporter 106 and a dynamic contact blade 105. A center on a first plane of the dynamic excitation contact base 107 is coaxially connected with a dynamic conducting rod 108, and an end of a circular column on a second plane of the dynamic excitation contact base 107 is coaxially connected with a dynamic contact blade 105; a dynamic stainless-steel supporter 106 is coaxially provided in the circular column of the dynamic excitation contact base 107. The static contact blade 104 with grooves are opposite to the dynamitic contact blade 105 with grooves, direction of the grooves between the static contact blade 104 and the dynamitic contact blade 105 are matched and aligned. Positions of the static excitation contact base 102 and the dynamic excitation contact base 107 are matched and a certain axial magnetic field is generated in the gap during the arc phase in the gap among the contacts.

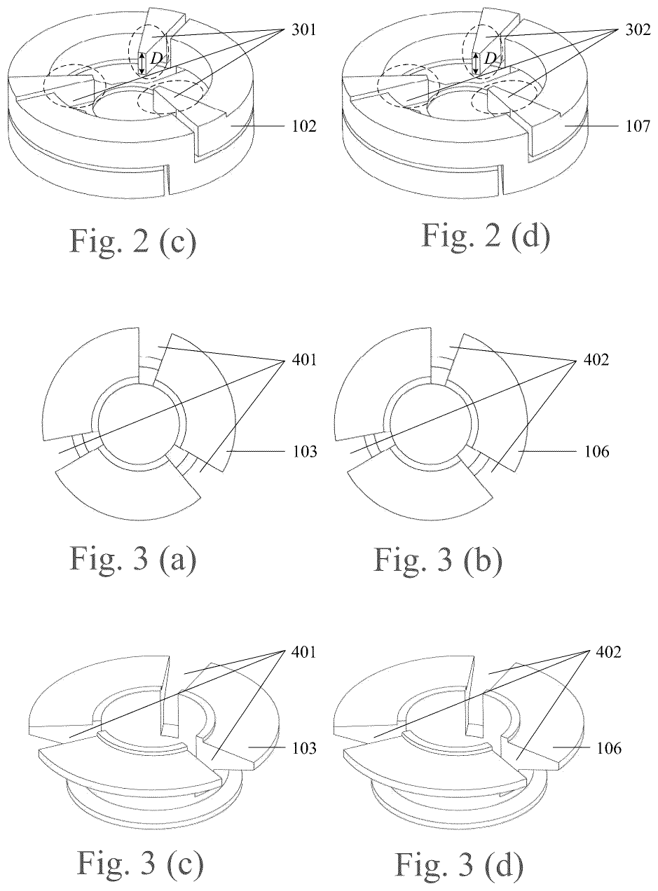

As shown in FIG. 2 (a), 2 (b), FIG. 2 (c), and FIG. 2 (d), a bottom planes of the static excitation contact base 102, the dynamic excitation contact base 107, the static contact blade 104 and the dynamic contact blade 105 are welded with a plurality of static terminal extending through-flow structures 301 which extend towards a center direction of the static excitation contact base 102 and a plurality of dynamic terminal extending through-flow structures 302, thus, the contact area of the static and the dynamic contact blades with the grooves are increased, cross-sectional area of the current is increased, and the current density at the connection is reduced. As shown in FIG. 2 (a) and FIG. 2 (b), the static terminal extending through-flow structures 301 and the dynamic terminal extending through-flow structures 302 are in a dotted circle. An extending distance L is smaller than 80% of a radius of the static excitation contact base 102 and the dynamic excitation contact base 107. As shown in FIG. 2 (c) and FIG. 2 (d), in the dotted circle, thicknesses D of the static terminal extending through-flow structures 301 and the dynamic terminal extending through-flow structures 302 are respectively less than 80% of a thickness of the static excitation contact base 102 and the dynamic excitation contact base 107.

FIG. 3 (a) and FIG. 3(b) are respectively a top view and a side view of the static stainless-steel supporter 103 and the dynamic stainless-steel supporter 106. As shown in FIG. 3 (a), FIG. 3(b), FIG. 3(c) and FIG. 3(d), static grooves 401 and dynamic grooves 402 which are circularly symmetric are respectively provided on the static stainless-steel supporter 103 and the dynamic stainless-steel supporter 106.

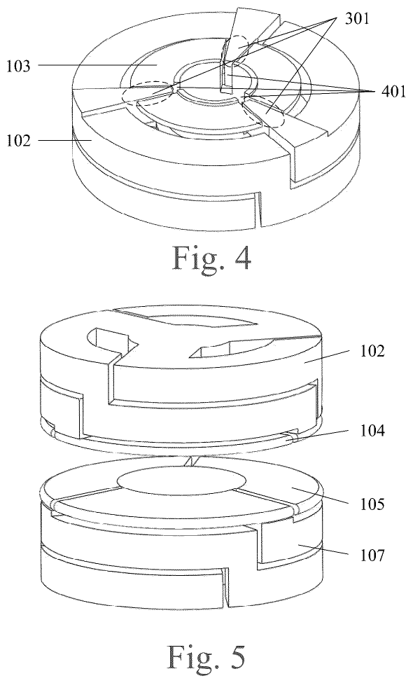

FIG. 4 is a schematic matching diagram of the static excitation contact base and the static stainless-steel supporter according to the preferred embodiment of the present invention. The static grooves 401 which are circularly symmetric are respectively provided on the static stainless-steel supporter 103. A shape of the static grooves 401 matches with a shape of the static terminal extending through-flow structures 301; and a depth of the static grooves 401 matches with a height of the static terminal extending through-flow structures 301, so as to ensure that the static terminal extending through-flow structures 301 and the static grooves 401 are matched in position and not contacted with each other. The dynamic excitation contact base 107 and the dynamic terminal extending through-flow structures 302 have the same matching structure. An amount of the static terminal extending through-flow structures 301 on the circular column of the static excitation contact base 102 is equal to or less than an amount of the static grooves 401; and an amount of the dynamic terminal extending through-flow structures 302 on the circular column of the dynamic excitation contact base 107 is equal to or less than an amount of the dynamic grooves 402.

FIG. 5 is a schematic matching diagram of the excitation contact base and its corresponding contact blade with a slot according to the preferred embodiment of the present invention. Grooves opening direction of the static contact blade 104 with the grooves and the dynamic contact blade 105 with the grooves are matched, and the grooves opening direction thereof are aligned. The grooves opening positions of the static contact blade 104 with the grooves are aligned with an protruding position edge of the static terminal extending through-flow structures 301 on the static excitation contact base 102; and the grooves opening positions of the dynamic contact blade 105 with the grooves are aligned with an protruding position edge of the dynamic terminal extending through-flow structures 302 on the dynamic excitation contact base 107, so as to ensure that a certain axial magnetic field is generated in the gaps among the contacts during burning stage.

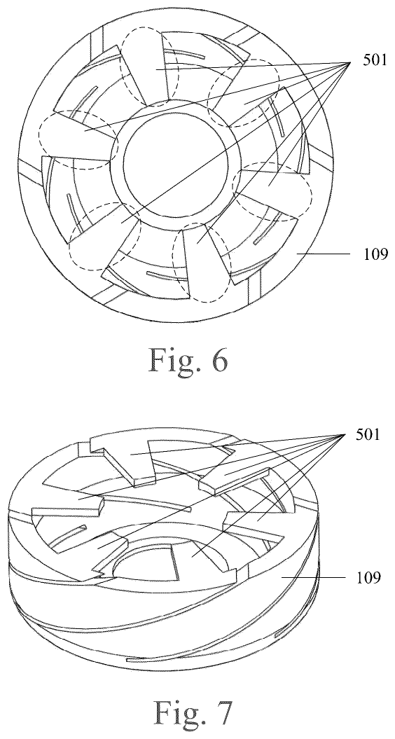

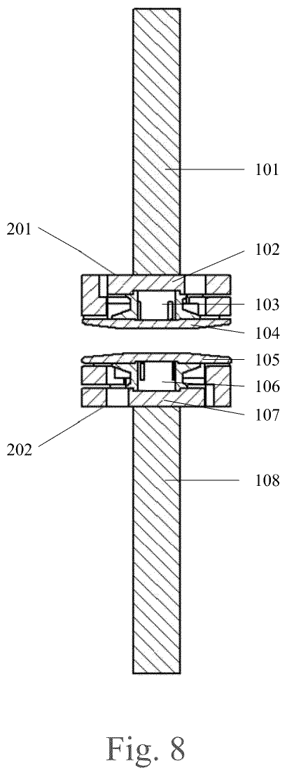

FIG. 6 and FIG. 7 are respectively a top view and a side view of the excitation contact base while being embodied as an excitation contact with a cup-shaped groove according to the preferred embodiment of the present invention. As shown in FIG. 6 and FIG. 7, when the static excitation contact base is a cup-shaped grooved excitation contact, an extending and through-flow structure 501 with an extending direction towards a center direction of a cup base is provided, in such a manner that a contact area of the cup-shaped grooved excitation contact and the contact blade with grooves is increased, a cross-sectional area of the current is increased, and a current density at the connection is reduced.

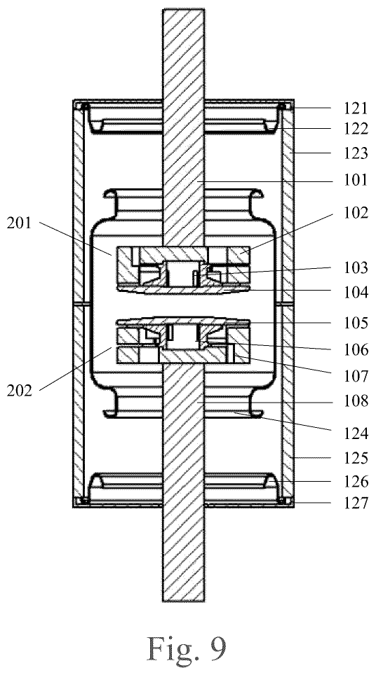

FIG. 9 is a plane schematic diagram of a vacuum interrupter for applying the high-flow current capacity contact according to the preferred embodiment of the present invention. As shown in FIG. 9, installation of guiding rods and contacts in the vacuum interrupter of the present invention is the same as in the conventional interrupters. From top to bottom, there are a vacuum interrupter static cover plate 121 and a static conducting rod 101 passing through a center of a static cover plate 121 of the vacuum interrupter. The static contact 201 comprises: a static conducting rod 101, a static excitation contact base 102, a static stainless-steel supporter 103 and a static contact blade 104. A center on a first plane of the static excitation contact base 102 is coaxially welded with a static conducting rod 101, and an end of a circular column on a second plane of the static excitation contact base 102 is coaxially welded with a static contact blade 104. A static stainless-steel supporter 103 is coaxially provided in the circular column of the static excitation contact base 102. A static insulation shell 123 is connected with the vacuum interrupter static cover plate 121; a dynamic insulation shell 125 is connected with the static insulation shell 123; a vacuum interrupter dynamic cover plate 127 is welded on the dynamic conducting rod 108 and provided on a low portion of the vacuum interrupter. The dynamic contact combination 202 comprises: a dynamic conducting rod 108, a dynamic excitation contact base 107, a dynamic stainless-steel supporter 106 and a dynamic contact blade 105. A center on a first plane of the dynamic excitation contact base 107 is coaxially connected with a dynamic conducting rod 108, and an end of a circular column on a second plane of the dynamic excitation contact base 107 is coaxially connected with a dynamic contact blade 105; a dynamic stainless-steel supporter 106 is coaxially provided in the circular column of the dynamic excitation contact base 107. A static terminal shielding 122, a central shielding 124 and a dynamic terminal shielding 126 are distributed inside the vacuum interrupter from top to bottom.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A high-flow current capacity contact, comprising: a static contact combination (201) and a dynamic contact combination (202), wherein:
the static contact (201) comprises a static excitation contact base (102), wherein a center on a first plane of the static excitation contact base (102) is coaxially connected with a static conducting rod (101), and an end of a circular column on a second plane of the static excitation contact base (102) is coaxially connected with a static contact blade (104);
a plurality of static terminal extending through-flow structures (301) extending towards a center of the static excitation contact base are uniformly provided on the circular column of the static excitation contact base (102) in integrity; an ending plane of the plurality of static terminal extending through-flow structures (301) protrudes a circular end plane of the static excitation contact base (102), end portions of the plurality of the static terminal extending through-flow structures (301) are fixedly connected with the static contact blade (104); a static stainless-steel supporter (103) is coaxially provided in the circular column of the static excitation contact base (102), a plurality of static grooves (401) are uniformly opened on the static stainless-steel supporter (103), positions and sizes of the static grooves (401) enable the static terminal extending through-flow structures (301) to be putted in, but sizes of the static grooves (401) are greater than sizes of the static terminal extending through-flow structures (301), in such a manner that the static terminal extending through-flow structures (301) are not in contact with the static stainless-steel supporter (103) to form a through-flow gap; the static stainless-steel supporter (103) is not fixedly connected with the static contact blade (104);
the dynamic contact combination (202) comprises a dynamic excitation contact base (107), wherein a center on a first plane of the dynamic excitation contact base (107) is coaxially connected with a dynamic conducting rod (108), and an end of a circular column on a second plane of the dynamic excitation contact base (107) is coaxially connected with a dynamic contact blade (105);
a plurality of dynamic terminal extending through-flow structures (302) extending towards a center of the dynamic excitation contact base are uniformly provided on the circular column of the dynamic excitation contact base (107) in integrity; an ending plane of the plurality of dynamic terminal extending through-flow structures (302) protrudes a circular end plane of the dynamic excitation contact base (107), end portions of the plurality of the dynamic terminal extending through-flow structures (302) are fixedly connected with the dynamic contact blade (105); a dynamic stainless-steel supporter (106) is coaxially provided in the circular column of the dynamic excitation contact base (107), a plurality of dynamic grooves (402) are uniformly opened on the dynamic stainless-steel supporter (106), positions and sizes of the dynamic grooves (402) enable the dynamic terminal extending through-flow structures (302) to be putted in, but sizes of the dynamic grooves (402) are greater than sizes of the dynamic terminal extending through-flow structures (302), in such a manner that the dynamic terminal extending through-flow structures (302) are not in contact with the static stainless-steel supporter (103) to form a through-flow gap; the dynamic stainless-steel supporter (106) is not fixedly connected with the dynamic contact blade (105);
the static contact blade (104) are in opposite position with the dynamic contact blade, and grooves opening positions of the static contact blade (104) correspond to grooves opening positions of the dynamic contact blade (105); the grooves opening positions of the static contact blade (104) are aligned with an protruding position edge of the static terminal extending through-flow structures (301) on the static excitation contact base (102); and the grooves opening positions of the dynamic contact blade (105) are aligned with an protruding position edge of the dynamic terminal extending through-flow structures (302) on the dynamic excitation contact base (107).

2. The high-flow current capacity contact, as recited in claim 1, wherein the static excitation contact base (102) and the dynamic excitation contact base (107) are a coil-type excitation contact base or a cup-shaped grooves excitation contact base.

3. The high-flow current capacity contact, as recited in claim 1, wherein an amount of the static terminal extending through-flow structures (301) on the circular column of the static excitation contact base (102) is equal to or less than an amount of the static grooves (401); an extending distance L of the static terminal extending through-flow structures (301) towards the center of the static excitation contact base is less than 80% of a radius of the static excitation contact base; and a thickness D of the static terminal extending through-flow structures (301) is less than 80% of a thickness of the static excitation contact base; and
an amount of the dynamic terminal extending through-flow structures (302) on the circular column of the dynamic excitation contact base (107) is equal to or less than an amount of the dynamic grooves (402); an extending distance L of the dynamic terminal extending through-flow structures (302) towards the center of the dynamic excitation contact base is less than 80% of a radius of the dynamic excitation contact base; and a thickness D of the dynamic terminal extending through-flow structures (302) is less than 80% of a thickness of the dynamic excitation contact base.

4. The high-flow current capacity contact, as recited in claim 1, wherein a groove-opening amount of the static contact blade (104) is equal to or greater than an amount of the static terminal extending through-flow structures (301); and a groove-opening amount of the dynamic contact blade (105) is equal to or greater than an amount of the dynamic terminal extending through-flow structures (302).

5. A vacuum interrupter, comprising: the high-flow current capacity contact as recited in claim 1, a vacuum interrupter static cover plate (121) welded on the static conducting rod (101); a static insulation shell (123) connected with the vacuum interrupter static cover plate (121); a dynamic insulation shell (125) connected with the static insulation shell (123); a vacuum interrupter dynamic cover plate (127) welded on the dynamic conducting rod (108) and provided on a low portion of the vacuum interrupter; and a static terminal shielding (122), a central shielding (124) and a dynamic terminal shielding (126) are distributed inside the vacuum interrupter from top to bottom.
